(19) United States
(12) Patent Application Publication
(10) Pub. No.: US 2021/0281063 A1
(43) Pub. Date: Sep. 9, 2021

(54) OVER CURRENT ISOLATION CIRCUITS

(71) Applicant: Hewlett-Packard Development Company, L.P., Spring, TX (US)

(72) Inventors: Poying Chih, Taipei (TW); Chao-Wen Cheng, Taipei (TW); Shu Ming Kuo, Taipei (TW)

(21) Appl. No.: 16/482,288

(22) PCT Filed: Oct. 19, 2017
(86) PCT No.: PCT/US2017/057314

§ 371 Date: Jul. 31, 2019

(51) Int. Cl. H02H 3/08; G06F 1/28; G06F 1/30; G06F 1/26

(52) U.S. Cl. CPC H02H 3/08; G06F 1/266; G06F 1/305; G06F 1/28

(57) ABSTRACT

An over current isolation circuit may, in an example, include a control chip, an input/output embedded controller communicatively coupled to the control chip, and an isolation circuit to isolate the control chip from an over current event based on a user selected preference to selectively enable and disable the signal of the over current event to the control chip.

### BACKGROUND

Computer ports, such as universal serial bus (USB) ports among others, are used to both transfer signal data to and from peripheral devices as well as provide power to the peripheral device. In some cases, a computing device associated with the port may be susceptible to over current from the peripheral device coupled to the port.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an over current isolation circuit according to an example of the principles described herein.

FIG. 2 is a block diagram of a computing device according to an example of the principles described herein.

FIG. 3 is a flowchart showing a method of selectively enabling and disabling the transfer of an over current signal to a PCH (205) according to an example of the principles described herein.

FIG. 4 is a schematic view of the over current isolation circuit according to an example of the principles described herein.

Throughout the drawings, identical reference numbers designate similar, but not necessarily identical, elements, The figures are not necessarily to scale, and the size of some parts may be exaggerated to more clearly illustrate the example shown. Moreover, the drawings provide examples and/or implementations consistent with the description: however, the description is not limited to the examples and/or implementations provided in the drawings.

### DETAILED DESCRIPTION

As described above, a computing device may include a number of ports that electrically couple the computing device to a peripheral device. The ports may be any type of port that communicatively couples a peripheral device to the computing device. During operation of the peripheral device, however, power surges may be experienced by the computer from the peripheral device. This over current event may be the result of a peripheral device communicatively coupled to the port drawing current that is relatively larger than a load switch allows. In this example, the load switch may send a signal to a platform controller hub (PCH) indicating that an over current event has occurred.

Some operating systems disable an over current-affected port and provide a pop-up message to a user of the computing device via a display device. This message may indicate that a power surge has occurred, which port was affected, and when the over current event occurred, among other information. When an over current event happens, this information is provided to the PCH which, in turn, prompts the pop-up window to appear. A user may click the message in order to cause the port to be usable again. However, the message may disappear after few seconds and no longer exist in, for example, an action center if the user did not click the message tab quickly enough. Failing to click on the message or click on the message a sufficient number of times renders the affected ports unusable. As a result, the port may be enabled by power cycling the computing device. Power cycling increases the time spent by the user and may lead to dissatisfaction with the computing device and its operation. The user may also, or instead, prefer not to have the pop-up windows interrupt use of the user's device.

The present specification describes an over current isolation circuit that selectively isolates an over current event occurring at a port from reaching the PCH. The over current isolation circuit allows a user to select over current event behavior at a BIOS setup menu in order to control whether a signal indicating an over current event has happened reaches the PCH or not. If a user selects an option to allow the Pal to receive the signal indicating an over current event has occurred, a switch between the port and the PCH is left closed, As a consequence, the message describing the over current event occurring is provided to the user of the computing device via a display device. If a user selects an option to not allow the PCH to receive the signal indicating an over current event has occurred, a switch between the port and the PCH is open preventing the signal from reaching the PCH, When this occurs, the port can be used immediately once the peripheral causing the over current condition is removed or otherwise communicatively decoupled from the computing device. In an example, the computing device may still be protected by a power switch or fuse associated with the port. By preventing the over current signal from reaching the PCH, the computing device will not have to be power cycled in order to restore functionality of the port.

The present specification describes an over current isolation circuit that includes a control chip, an input/output embedded controller communicatively coupled to the control chip, and a circuit to isolate the control chip from an over current event based on a user selected preference to selectively enable and disable the signal of the over current event to the control chip.

The present specification further describes a computing device that includes a platform controller hub (PCH), an input/output embedded controller communicatively coupled to the platform controller hub, at least one port communicatively coupled to the PCH and input/output controller, and at least one gate controlled by the input/output controller that selectively enables and disables a signal of an over current event being detected by the PCH.

The present specification also describes a method that includes detecting an over current event on a port, passing a signal representing the over current event from a load switch associated with the USB port through a gate, and selectively enabling and disabling the transfer of the signal to a platform controller hub (PCH).

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

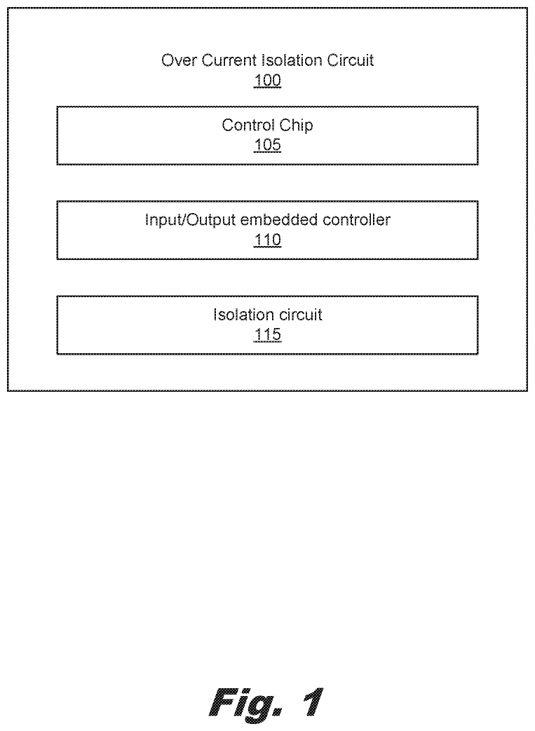

FIG. 1 is a block diagram of an over current isolation circuit (100) according to an example of the principles described herein. The over current isolation circuit (100) may include a control chip (105), an input/output embedded controller (110), and an isolation circuit (115). Additional electrical components mat be associated with the over current isolation circuit (100) such as port circuitry electrically coupled to the over current isolation circuit (100) that, during an overcurrent event, send signals to the over current isolation circuit (100) to be addressed as described herein.

In an example, the over current isolation circuit (100) forms a part of a computing device. Examples of computing devices include servers, desktop computers, laptop computers, personal digital assistants (PDAs), mobile devices, smartphones, gaming systems, and tablets, among other electronic devices.

In an example, the over current isolation circuit (100) may be implemented as a physical circuit within a computing device. In these examples, the overcurrent isolation circuit (100) may be implemented by the computing device through interaction with computer readable program code executed by a processor of the computing device. In an example, the computing device may be utilized in any data processing scenario including, stand-alone hardware, mobile applications, through a computing network, or combinations thereof, Further, the over current isolation circuit (100) may be used in a computing network, a public cloud network, a private cloud network, a hybrid cloud network, other forms of networks, or combinations thereof. The present systems may be implemented on one or multiple hardware platforms, in which the modules, being computer readable program code, in the system can be executed on one or across multiple platforms. In another example, the methods provided by the over current isolation circuit (100) are executed by a local administrator.

To achieve its desired functionality, the computing device maintaining the over current isolation circuit (100) includes various hardware components. Among these hardware components may be a number of processors, a number of data storage devices, a number of peripheral device adapters, and a number of network adapters. These hardware components may be interconnected through the use of a number of busses and/or network connections. In one example, the processor, data storage device, peripheral device adapters, and a network adapter may be communicatively coupled via a bus.

The processor of the computing device maintaining the over current isolation circuit (100) may include the hardware architecture to retrieve executable code from the data storage device and execute the executable code. The executable code may, when executed by the processor, cause the processor to implement at least the functionality of the over current isolation circuit (100), according to the methods of the present specification described herein. In an example, such functionality includes detecting an over current event on a port, passing a signal representing the over current event from a load switch associated with the port to a gate, and selectively enabling and disabling the transfer of the signal to a platform controller hub (PCH). In the course of executing code, the processor may receive input from and provide output to a number of the remaining hardware units.

The data storage device may store data such as executable program code that is executed by the processor or other processing device. The data storage device may specifically store computer code representing a number of applications that the processor executes to implement at least the functionality described herein.

The data storage device may include various types of memory modules, including volatile and nonvolatile memory. For example, the data storage device of the present example includes Random Access Memory (RAM), Read Only Memory (ROM), and Hard Disk Drive (HOD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processor may boot from Read Only Memory (ROM), maintain nonvolatile storage in the Hard Disk Drive (HDD) memory, and execute program code stored in Random Access Memory (RAM).

Generally, the data storage device may include a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the computing device enable the processor to interface with various other hardware elements, external and internal to the computing device include those peripheral devices coupled to the computing device via the port, For example, the peripheral device adapters may provide an interface to input/output devices, such as, for example, display device, a mouse, or a keyboard. The peripheral device adapters may also provide access to other external devices such as an external storage device, a number of network devices such as, for example, servers, switches, and routers, client devices, other types of computing devices, and combinations thereof.

The display device may be provided to allow a user of the computing device associated with the over current isolation circuit (100) to interact with and implement the functionality of the over current isolation circuit (100). The peripheral device adapters may also create an interface between the processor and the display device, a printer, or other media output devices. The network adapter may provide an interface to other computing devices within, for example, a network, thereby enabling the transmission of data between the computing device and other devices located within the network.

The computing device may, when executed by the processor, display the number of graphical user interfaces (GUIs) on the display device associated with the executable program code representing the number of applications stored on the data storage device. The GUIs may include aspects of the executable code including presentation of basic input/output system (BIOS) menus and displays that provide a user with the ability to select whether or not an overcurrent signal is passed onto a platform controller hub (PCH) according to the principles described herein. This may be done via a user making a number of interactive gestures on the GUIs of the display device. Examples of display devices include a computer screen, a laptop screen, a mobile device screen, a personal digital assistant (PDA) screen, and a tablet screen, among other display devices.

The computing device may execute, along with a BIOS, certain operating systems. Examples of operating systems includes WINDOWS® operating system developed and distributed by Microsoft Corporation; UBUNTU® operating system developed and distributed by Canonical Ltd.; UNIX® operating system developed by American Telephone and Telegraph Company and distributed as an open source software package; LINUX® Unix-based operating system developed and distributed as an open source software package; ANDROID® Linux-based operating system developed and distributed by Google, Inc.; BERKELEY SOFTWARE DISTRIBUTION (BSD) Unix-based operating system developed and distributed by the Computer Systems Research Group (CSRG) of the University of California, Berkeley; iOS® operating system developed and distributed by Apple Inc.; Mac OS X operating system developed and distributed by Apple Inc.

As described above, the over current isolation circuit (100) includes a control chip (105). In an example, the control chip (105) is a platform control hub (PCH). The control chip (105) may be electrically coupled a port of the computing device. In an example, a load switch may be placed between the port and the control chip (105) as an overcurrent detector that protects the control chip (105) as well as other devices with in the computing device from being affected by a surge. The load switch may detect the overcurrent at the port and propagate a signal to the control chip (105). Without the input/output embedded controller (110) and the isolation circuit (115) as descried herein, the signal from the load switch will reach the control chip (105) uninterrupted. When this occurs, the control chip (105) may present to a user of the computing device a notice or pop-up window indicating that the port has experienced an over current event and has been disabled. If a user were to address the pop-up window quick enough, the user could cause the port to be reset and once again made operational. However, if a user does not know how to address the overcurrent event notice or address that notice quick enough, the pop-up window may disappear preventing the user from being able to address the overcurrent issue.

The presently described over current isolation circuit (100), therefore, includes an input/output embedded controller (110) coupled to an isolation circuit (115). During operation, the input/output embedded controller (110) and isolation circuit (115) may intercept the over current signal from the load switch, and based on user specific preferences, either allows the over current signal to pass onto the control chip (105) or prevents the over current signal from reaching the control chip (105). The input/output embedded controller (110) may be a controller associated with the BIOS of the computing device that executes the instructions preventing or allowing the over current to pass to the control chip (105) based on the user specified preference. In an example, the input/output embedded controller (110) may execute computer readable program code defining user-specified instructions that send a signal to a gate within the isolation circuit (115) directing the gate to be placed in a relatively high or relatively low state according to those instructions.

During operation of the input/output embedded controller (110), the isolation circuit (115) may be opened or closed based on whether the user preferences have been set for the control chip (105) to receive or not receive, respectively, the over current signal. In an example, the isolation circuit (115) includes at least one gate and a number of electrical leads electrically coupling the input/output embedded controller (110) to the gate. In an example, the number of gates electrically coupled to the input/output embedded controller (110) may be equal to the number of sets of ports and load switches associated with the computing device. Each gate of the isolation circuit (115) may be provided with a signal from the input/output embedded controller (110) indicating whether the gate should be set to a high voltage potential or a low voltage potential. In an example, a general-purpose input/output pin on the input/output embedded controller (110) may be responsible for setting the gate voltage potential at the gates of the isolation circuit (115).

At a high voltage potential, the gate of the isolation circuit (115) allows the signal representative of an overcurrent event to be passed along to the control chip (105). As described above, a pop-up window may be provided to the user indicating that the port has been disabled due to an over current event. Without interaction from the user, the port will remain disabled until the computing device has been power cycled and the port is reset as a result.

At a low voltage potential at the gate of the isolation circuit (115), the over current signal may be prevented from reaching the control chip (105). As a result, the user is not subjected to time sensitive and confusing processes used to correct the disablement of the port due to the overcurrent signal reaching the control chip (105). At the same time, the computing device and other peripheral devices are not damaged by the overcurrent event due to the inclusion of the load switch. The port can be used immediately once the peripheral device causing the overcurrent event is removed.

The over current isolation circuit (100), therefore, provides added flexibility due to the alternative options in addressing overcurrent events at ports. There are no confusing or complicated processes used by a user to cause the port functionality to be reinstated or recovered. However, the user may still be provided with the option, via setting a BIOS preference, to receive a pop-up notice should that be more convenient for the user.

In an example, the over current isolation circuit (100) may further include a voltage source coupled between the gates and the control chip (105). The voltage source may consistently provide a voltage to the control chip (105) indicating a digital “1” at the control chip (105) regardless whether the over current signal from the load switch is allowed to pass through the gate or not.

As described above, the input/output embedded controller (110) may be communicatively coupled to a processor of the computing device that executes a BIOS. The BIOS may present, to a user, certain GUIs that allows a user to set the gates of the isolation circuit (115) to either a high or low state as described herein. In some examples, a user may be provided with a GUI that explains the two options clearly such that a user may feel relatively more comfortable knowing how the computing device will react during an over current event.

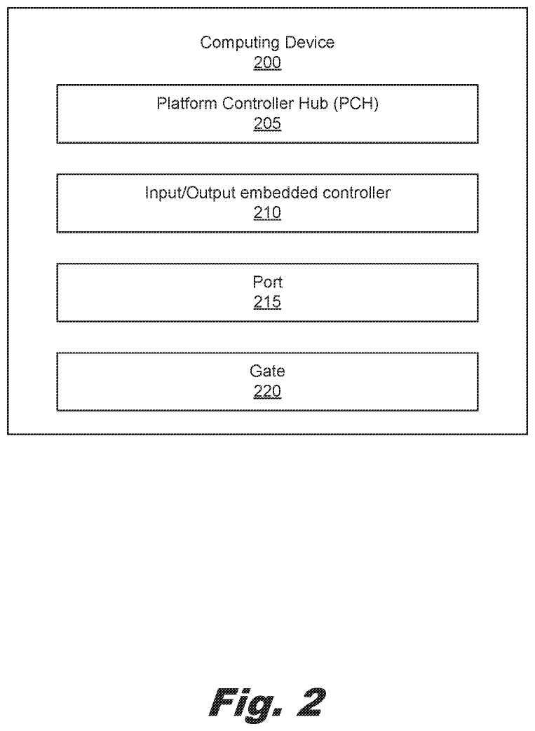

FIG. 2 is a block diagram of a computing device (200) according to an example of the principles described herein. The computing device (200) may include a PCH (205), an input/output embedded controller (210), at least one port (215), and at least one gate (220). The PCH (205) may be similar to the control chip (FIG. 1, 105) as described and shown in FIG. 1. Additionally, the input/output embedded controller (210) may be similar to the input/output embedded controller (FIG. 1, 110) as described and shown in FIG. 1.

As mentioned herein, the computing device (200) may further include at least one port (215) to communicatively and/or electrically couple a peripheral device to the computing device (200). The port (215) may further include a load switch to prevent an overcurrent from reaching the platform control hub (PCH) (205) as well as provide a signal to the PCH (205) that an over current event has occurred. As described herein, however, the input/output embedded controller (210) along with the gate (220) may selectively allow or prevent the signal describing that an over current event has occurred from reaching the PCH (205).

The gate (220) may be any type of gate including, but not limited to, a MOSFET, a bipolar junction transistor, or a buffer integrated circuit among other types of gates. During operation, a user may access the BIOS of the computing device (200) in order to effectively set the gate (220) to a high or low state as described herein. In an example, setting the gate (220) to a high state may cause the signal from the load switch associated with the port to reach the PCH (205) through the gate (220) as described herein. In this example, setting the gate (220) to a low state may prevent the signal from the load switch from reaching the PCH (205). In other examples, different types and/or designs of gates may be set differently in order to selectively enable a signal from the load switch to reach the PCH (205). The present specification, therefore, contemplates the use of those other types and/or designs of gates and the examples described herein are meant to be example implementations for convenience in understanding.

In an example, the BIOS may maintain user preferences that control the input/output embedded controller (210) to set the voltages at the gate (220). In this example, a user may be presented with at least one preferences selection GUI that allows a user to determine whether the (PCH) (205) receives the over current signal from the load switch associated with the port (215).

The configuration of the BIOS may be done at booting of the computing device (200) by presenting to a user a number of GUIs. Additionally, the BIOS may be accessed after booting of an operating system on the computing device (200) via, for example, administrator access.

The port (215) may be any type of port (215) used to couple a peripheral device to the computing device (200). The port (215) may include any version of a universal serial bus (USB) port, any type of serial port, and any type of parallel ports, among others. The present specification, therefore, contemplates the use of the PCH (205), input/output embedded controller (210), and gate (220) as described herein in order to selectively prevent or allow an over current signal from reaching the PCH (205).

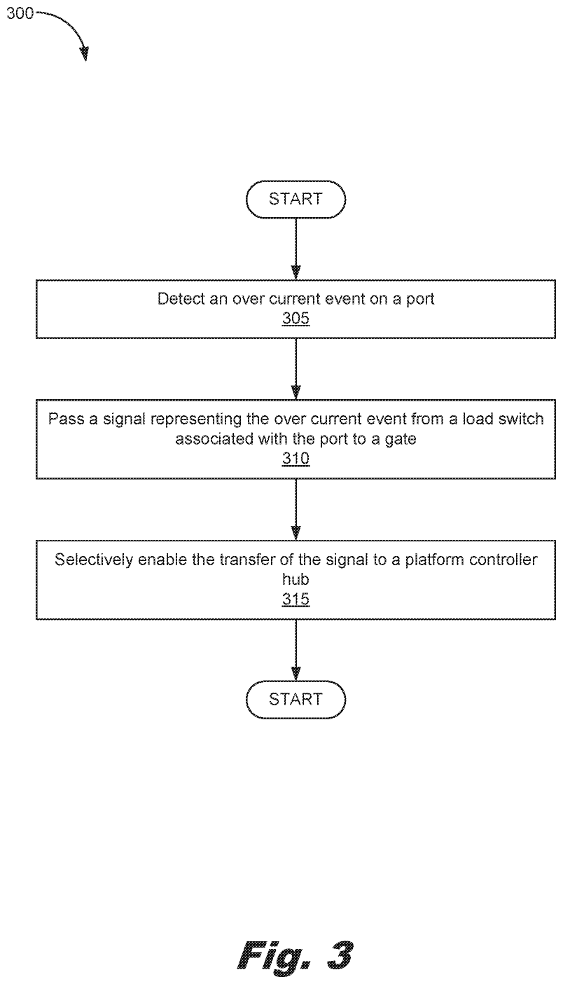

FIG. 3 is a flowchart showing a method (300) of selectively enabling and disabling the transfer of an over current signal to a PCH (205) according to an example of the principles described herein. As described herein, the method (300) may begin with detecting (305) an over current event on a port. Detection of the overcurrent event may be conducted by a load switch associated with a port (215) of a computing device (200). The over current event may be a result of a damaged peripheral device, a power surge, or other types of actions or occurrences by or on a computing device (200).

The method (300) may further include passing (310) a signal representing the over current event from a load switch associated with the port to a gate (220). As described above, the gate (220) is placed electrically between the load switch/port (215) and the PCH (205). The method continues there by selectively enabling (315) the transfer of the signal to a PCH (205). As described herein, a user may access a BIOS in order to set a preference whether the gate (220) should or should not pass the over current signal to the PCH (205). The input/output embedded controller (210) may therefore set the gate to either a high or low voltage, according to the preferences selected by the user.

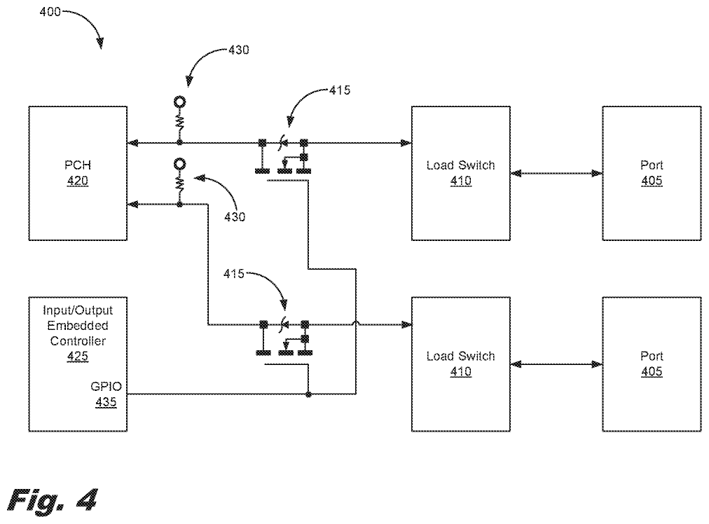

FIG. 4 is a schematic view of the over current isolation circuit (400) according to an example of the principles described herein. As depicted, the over current isolation circuit (400) includes at least one port (405) electrically coupled to a load switch (410), As can be seen from FIG. 4, each port (405) includes its own load switch (410) but in some examples a plurality of ports (405) may be electrically coupled to a single load switch (410). However, where each port (405) includes its own load switch (410), an over current signal may be sent by each load switch (410) representative of the status of each of the ports (405) individually.

The over current isolation circuit (400) further includes at least one gate (415) placed electrically between each of the load switches (410) and a PCH (420). As described herein, the gates (415) selectively allow or disallow the over current signal from the load switches (410) from reaching the PCH (420) depending on whether the gates (415) are set to a high voltage or a low voltage by the input/output embedded controller (425). In examples where a plurality of gates (220) are present, each of the gates (220) may be set to a voltage potential according to preferences set by the user on the BIOS GUI described herein. In some cases, a user may wish to allow the over current signal originating from a specific load switch (410) associated with a specific port (405) to pass to the PCH (420). In this example, a user may, via the BIOS, set the voltage potential to other gates (415) such that the over current signal from another load switch (410)/port (405) is not received by the PCH (420). Allowing a user to be selective on a port-by-port basis allows greater flexibility and use in the computing device.

In an example, the voltage potential of each of the gates (415) is set by the input/output embedded controller (425) using a general-purpose input/output pin (435) on the input/output embedded controller (425).

The over current isolation circuit (400) may further include a voltage source (430) coupled between the gates (415) and the PCH (420). The voltage source (430) may consistently provide a voltage to the PCH (420) indicating a digital “1” at the PCH (420) regardless of whether the over current signal from the load switches (410) are allowed to pass through the gates (415) or not.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special-purpose computer, or other programmable data processing apparatus to produce a machine, such that the computer usable program code, when executed via, for example, the processor of the computing device or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe an over current isolation circuit that allows a user to selectively allow or disallow an overcurrent signal from a load switch from reaching a PCH. Preferences as to how the gates described herein are set may be done via a BIOS GUI by a user operating the computing device. This allows for an alternative option of port over current protection behavior that isolates an over current event from the PCH instead of allowing the PCH to create a pop-up window or other notice to a user of the computing device. This may result in the avoidance of complicated processes by the user in order to restore functionality to the port. Additionally, by preventing the over current signal from reaching the PCH, the computing system will not have to be power cycled in order to restore that functionality should the user fail to address the pop-up window or notice from the PCH. When the over current signal is prevented from reaching the PCH, a user can restore functionality to the port when the power surge condition is removed. GUIs may be provided that clearly show a user how to adjust the settings of the gates.

The preceding description has been presented to illustrate and describe examples of the principles described. This description is not intended to be exhaustive or to limit these principles to any precise form disclosed. Many modifications and variations are possible in light of the above teaching.

What is claimed is:

1. An over current isolation circuit, comprising:
a control chip;
an input/output embedded controller communicatively coupled to the control chip; and
an isolation circuit to isolate the control chip from an over current event based on a user selected preference to selectively enable and disable the signal of the over current event to the control chip.

2. The over current isolation circuit of claim 1, wherein the user selected preference to selectively enable and disable the notification of the over current event to the control chip is provided in a graphical user interface presented to a user by a basic input/output system (BIOS) of a computing device associated with the over current detection circuit.

3. The over current isolation circuit of claim 1, wherein the input/output embedded controller is communicatively coupled to the control chip through a gate that selectively prevents and allows the signal of the over current event to the control chip.

4. The over current isolation circuit of claim 3, wherein the gate is one of a MOSFET, a bipolar junction transistor, or buffer integrated circuit.

5. The over current isolation circuit of claim 3, wherein the gate is placed on an over current signaling line electrically coupling a universal serial bus (USB) port to the control chip.

6. The over current isolation circuit of claim 1, wherein the control chip is a platform controller hub.

7. A computing device, comprising:
a platform controller hub (PCH);
an input/output embedded controller communicatively coupled to the platform controller hub;
at least one port communicatively coupled to the PCH and input/output controller; and
at least one gate controlled by the input/output controller that selectively enables and disables a signal of an over current event being detected by the PCH.

8. The computing device of claim 7, the at least one gate is a MOSFET, a bipolar junction transistor, or buffer integrated circuit.

9. The computing device of claim 7, further comprising at least one load switch to detect the over current event at the at least one USB port.

10. The computing device of claim 7, wherein selectively enabling and disabling the signal of an over current event being detected by the PCH is a user selected preference.

11. The computing device of claim 10, wherein the user selected preference is provided in a graphical user interface presented to a user by a basic input/output system (BIOS) of the computing device.

12. The computing device of claim 7, wherein disabling the signal of an over current event results in use of the USB port after the over current event as soon as the over current event is removed.

13. A method comprising:
detecting an over current event on a port;
passing a signal representing the over current event from a load switch associated with the port to a gate; and
selectively enabling the transfer of the signal to a platform controller hub (PCH).

14. The method of claim 13, wherein enabling the transfer of the signal to the PCH is accomplished through placing a gate in a high input impedance state which allows the signal to be passed to the PCH.

15. The method of claim 13, wherein disabling the transfer of the signal to the PCH is accomplished through placing a gate in a low input impedance state which prevents the signal to be passed to the PCH.
